(19) United States
(12) Patent Application Publication
(10) Pub. No.: US 2024/0386277 A1
(43) Pub. Date: Nov. 21, 2024

(54) COMPUTER-READABLE RECORDING MEDIUM STORING REINFORCEMENT LEARNING PROGRAM, REINFORCEMENT LEARNING METHOD, AND INFORMATION PROCESSING APPARATUS

(71) Applicant: Fujitsu Limited, Kawasaki-shi (JP)

(72) Inventors: Kanata SUZUKI, Kawasaki (JP); Yoshinobu IIMURA, Kawasaki (JP); Masatoshi OGAWA, Zama (JP)

(73) Assignee: Fujitsu Limited, Kawasaki-shi (JP)

(21) Appl. No.: 18/640,007

(22) Filed: Apr. 19, 2024

(30) Foreign Application Priority Data
May 17, 2023 (JP) 2023-081533

(51) Int. Cl. G06N 3/092

(52) U.S. Cl. CPC G06N 3/092

(57) ABSTRACT

A recording medium stores a reinforcement learning program for causing a computer to execute a process. The process includes: calculating a second demand amount after a certain period of time and a reliability of the second demand amount based on a current first demand amount for a service provided in a predetermined environment; determining an action to be performed for the environment in accordance with a machine learning model based on input data that includes the second demand amount, the reliability, and a current first state of the environment; executing the determined action for the environment; and updating, based on a second state of the environment after the action is performed and a reward, a parameter of the model by constrained reinforcement learning in which the reward is increased in a range that satisfies a constraint on the state of the environment.

### CROSS-REFERENCE TO RELATED APPLICATION

This application is based upon and claims the benefit of priority of the prior Japanese Patent Application No. 2023-081533, filed on May 17, 2023, the entire contents of which are incorporated herein by reference.

### FIELD

The embodiments discussed herein are related to a computer-readable recording medium storing a reinforcement learning program, a reinforcement learning method, and an information processing apparatus.

### BACKGROUND

Reinforcement learning is one of techniques of machine learning. In the reinforcement learning, an agent in a certain environment observes a current state and determines an action to be taken. The agent obtains a reward from the environment by selecting the action. Training about a policy that gives a largest reward through a series of actions is performed in the reinforcement learning. For example, there is also reinforcement learning in which a constraint to be satisfied is provided. When the constraint is provided, a model for determining an action satisfying the constraint is generated.

For example, constrained reinforcement learning may be used for base station control for optimizing power consumption of a wireless access network. In this case, a model for controlling switching between an active state and a sleep state of a plurality of base stations is generated by the constrained reinforcement learning. The constraint in the model for the base station control is, for example, that a load of each base station does not exceed an upper limit.

As a technique related to the control of power consumption of the base station or the like, for example, there has been proposed a technique for generating control information for performing control with suppressed power consumption while suppressing a risk of a failure of the control. A technique for reducing switching overhead due to frequent resource switching in a base station device that aggregates baseband processing for a plurality of base stations has also been proposed. A technique has also been proposed in which past traffic data is analyzed by using an artificial intelligence model, an amount exceeding a capacity for a base station is predicted, and an unmanned vehicle is dispatched to the base station. A technique for performing a power-saving operation in real time, suppressing inappropriate power-saving processing and serious congestion of user access, and reducing the number of error bits has also been proposed. A technique for reducing power consumption based on analysis of a traffic pattern in a base station of a cellular communication network has also been proposed.

An energy-aware mobile traffic offload method in a heterogeneous network has been proposed in which decision making in a deep Q network (DQN) and advanced traffic demand prediction are jointly applied.

As a reinforcement learning model, for example, a neural network may be used. As a technique related to the neural network, for example, a new class of network model obtained by combining a neural network in the related art and a mixed density model has been proposed.

Japanese Laid-open Patent Publication No. 2016-189529, International Publication Pamphlet No. WO 2015/045444, U.S. Patent Application Publication No. 2022/0394512, Japanese National Publication of International Patent Application No. 2015-515196, and U.S. Patent Application Publication No. 2020/0045627 are disclosed as related art.

Chih-Wei Huang, Po-Chen Chen, “Mobile Traffic Offloading with Forecasting using Deep Reinforcement Learning”, arXiv: 1911.07452, 18 Nov. 2019 is also disclosed as related art.

### SUMMARY

According to an aspect of the embodiments, a computer-readable recording medium storing a reinforcement learning program for causing a computer to execute a process including: calculating a second demand amount after a certain period of time and a reliability of the second demand amount based on a current first demand amount for a service provided in a predetermined environment; determining an action to be performed for the environment in accordance with a machine learning model based on input data that includes the second demand amount, the reliability, and a current first state of the environment; executing the determined action for the environment; and updating, based on a second state of the environment after the action is performed and a reward, a parameter of the model by constrained reinforcement learning in which the reward is increased in a range that satisfies a constraint on the state of the environment

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a reinforcement learning method according to a first embodiment;

FIG. 2 is a diagram illustrating an example of hardware of a computer;

FIG. 3 is a block diagram illustrating an example of functions of the computer for realizing constrained reinforcement learning;

FIG. 4 is a diagram illustrating an example of a constrained reinforcement learning operation;

FIG. 5 is a diagram illustrating an example of a prediction variance;

FIG. 6 is a diagram illustrating an example of an action by constrained reinforcement learning in a second embodiment;

FIG. 7 is a flowchart illustrating an example of a processing procedure of the constrained reinforcement learning;

FIG. 8 is a diagram illustrating an example of a prediction result by a model obtained by the constrained reinforcement learning using the prediction variance;

FIG. 9 is a diagram illustrating an example of an action by constrained reinforcement learning in a third embodiment;

FIG. 10 is a flowchart illustrating an example of a prediction processing procedure using a trained model by the constrained reinforcement learning;

FIG. 11 is a diagram illustrating an example of a verification result in a case where a predicted traffic amount to which a margin according to a prediction variance is added is input; and

FIG. 12 is a diagram illustrating an example of a base station management system in a wireless access network.

### DESCRIPTION OF EMBODIMENTS

It is difficult to control a behavior of a model as intended in the reinforcement learning. Because of characteristics of such reinforcement learning, in the constrained reinforcement learning, an index related to a constraint often exceeds a threshold as a result of a behavior of the model after training. When the constraint is not observed, a problem may occur in control using the model. For example, in control of a base station in a wireless access network, when a constraint on a load of the base station is violated, congestion of communication occurs.

According to one aspect, an object of the present disclosure is to suppress a constraint from being violated.

Hereinafter, the present embodiments will be described with reference to the drawings. Each embodiment may be implemented by combining a plurality of embodiments within a range without contradiction.

### First Embodiment

A first embodiment is a reinforcement learning method that suppresses a constraint in constrained reinforcement learning from being violated by effectively using a reliability of a predicted demand amount of a service performed in an environment.

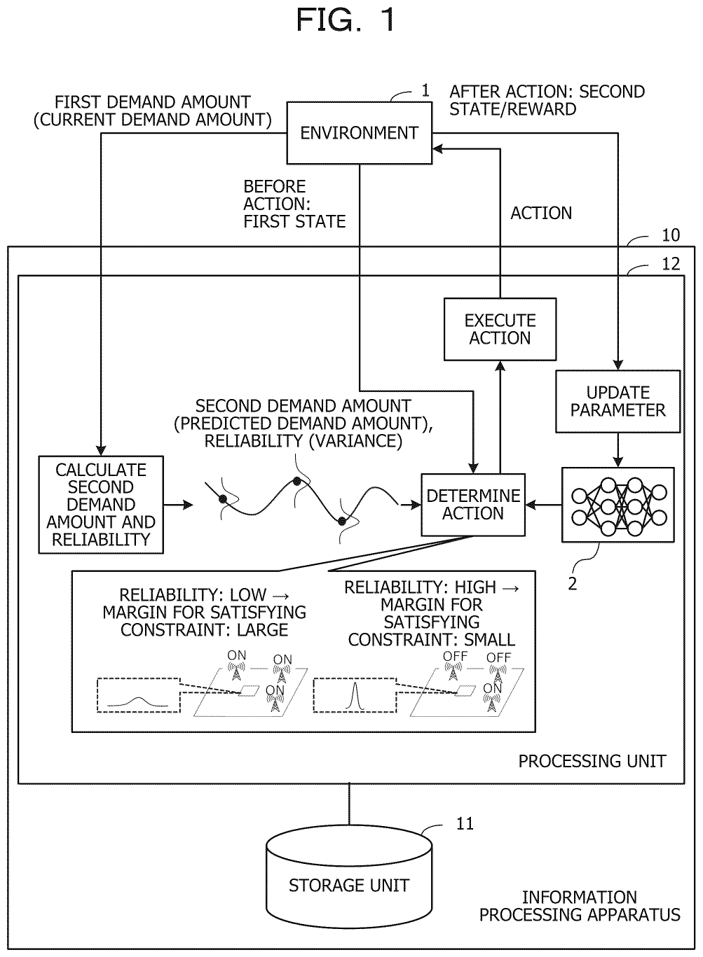

FIG. 1 is a diagram illustrating an example of a reinforcement learning method according to the first embodiment. FIG. 1 illustrates an information processing apparatus 10 that performs the reinforcement learning method. For example, by executing a reinforcement learning program, the information processing apparatus 10 is able to perform the reinforcement learning method.

The information processing apparatus 10 includes a storage unit 11 and a processing unit 12. The storage unit 11 is, for example, a memory or a storage device included in the information processing apparatus 10. The processing unit 12 is, for example, a processor or an arithmetic circuit included in the information processing apparatus 10.

For example, the storage unit 11 stores an initial state of a model 2. The storage unit 11 stores the model 2 after being trained by the processing unit 12.

The processing unit 12 performs constrained reinforcement learning of the model 2. For example, the processing unit 12 calculates a second demand amount (predicted demand amount) after a certain period of time and a reliability of the second demand amount based on a current first demand amount (current demand amount) for a service provided in a predetermined environment 1. The reliability is a numerical value indicating how reliable the second demand amount calculated as a predicted value after the certain period of time is. As the reliability, for example, a variance (a square of a difference between a candidate value (a possible value of a random variable) of the second demand amount and an expected value (an average value)) of the random variable of the second demand amount may be used.

Based on input data that includes the second demand amount, the reliability, and the current first state of the environment 1, the processing unit 12 determines an action to be performed for the environment 1 in accordance with the machine learning model 2. For example, the processing unit 12 performs calculation in accordance with the model 2 by using the second demand amount, the reliability, and the current first state of the environment 1 as inputs to the model 2, and obtains an output of the model 2. The output of the model 2 indicates the action to be performed for the environment 1. The processing unit 12 executes the action determined for the environment 1.

When the action is performed, the state of the environment 1 changes from the first state to a second state. Based on the second state of the environment 1 after the action is performed and a reward, the processing unit 12 updates a parameter of the model 2 by constrained reinforcement learning that increases the reward in a range that satisfies a constraint on the state of the environment 1.

The processing unit 12 repeats the update of the parameter of the model 2 by such processing. Accordingly, the constraint is suppressed from being violated in the action determination processing using the model 2. For example, although the constrained reinforcement learning updates the parameter of the model 2 so as to increase the reward in the range satisfying the constraint, it may not be completely avoided that the environment 1 transitions to a state that does not satisfy the constraint as a result of the action determined in accordance with the model 2. By including the reliability of the predicted second demand amount in the input data of the model 2, the model 2 is trained such that when the reliability is low, a margin for satisfying the constraint is set to be large, and when the reliability is high, the margin for satisfying the constraint is set to be small. As a result, the constraint is suppressed from being violated.

As the environment 1, for example, a communication environment of a wireless access network is conceivable. In this case, the service provided in the environment 1 is a wireless information communication service in response to a request from a terminal of a user.

A base station in the wireless access network is desirably set to a sleep state (a state in which communication with the terminal is not performed) to suppress power consumption when a communication traffic amount is small. On the other hand, when there are too many base stations in the sleep state, it is not possible to cope with an increase in the communication traffic amount in a short time, and congestion may occur. It is important to avoid the occurrence of congestion as much as possible in the wireless access network. Accordingly, for example, reinforcement learning is performed under a constraint that a load of the base station does not exceed a threshold of the load.

When generating the model 2 for the base station control of the wireless access network, a current first communication traffic amount in the communication environment of the wireless access network is a first demand amount. Based on the first communication traffic amount, the processing unit 12 calculates a second communication traffic amount after the certain period of time in the wireless access network as a second demand amount. A first state for the wireless access network is, for example, a load (first load) of the base station.

Based on the second communication traffic amount, the reliability, and the first load of the base station in the wireless access network, the processing unit 12 determines, in accordance with the model 2, whether to cause the base station to be active or sleep in the action determination processing. The processing unit 12 instructs a device for the base station control in the wireless access network to control the state of the base station as determined.

After the instruction to control the base station, the processing unit 12 generates a penalty when a load (second load) of the base station after controlling the base station exceeds a threshold related to the load of the base station. The processing unit 12 sets a larger value as a reward, as power consumption of the base station after controlling the base station is smaller. The processing unit 12 updates the parameter of the model 2 so as to increase the reward without generating a penalty. For example, the penalty is given as a negative reward, and the processing unit 12 updates the parameter of the model 2 so as to increase a sum of the negative reward based on the penalty and the reward (positive reward) according to the load.

Accordingly, the model 2 is generated that provides a margin in communication capability to the base station in the active state when a state is at state in which it is difficult to accurately predict the communication traffic amount after the certain period of time. The model 2 is generated that causes a larger number of base stations to be in the sleep state when the state is in a state in which it is possible to sufficiently accurately predict the communication traffic amount after the certain period of time. By causing the device that controls the base station to control the base station using the model 2, it is possible to reduce overall power consumption while suppressing the occurrence of congestion due to the load of the base station exceeding a threshold.

By using the reliability of the predicted demand amount not at the time of training the model 2 but at the time of determining an action using the generated model 2, it is also possible to suppress the constraint from being violated. For example, the processing unit 12 performs the following processing by using the model 2 generated by performing the constrained reinforcement learning that increases the reward in the range that satisfies the constraint on the state of the environment 1 without using the reliability.

Based on the current first demand amount for the service provided in the predetermined environment 1, the processing unit 12 calculates a second demand amount after a certain period of time and a reliability of the second demand amount. The processing unit 12 obtains a third demand amount by adding a value according to the reliability to the second demand amount. Based on the input data that includes the third demand amount and the current first state of the environment 1, the processing unit 12 determines an action to be performed for the environment 1 in accordance with the model 2 generated by the constrained reinforcement learning that increases the reward in the range that satisfies the constraint on the state of the environment 1. The processing unit 12 executes the determined action for the environment 1.

As a result, when the reliability is low, the predicted demand amount is excessively estimated, and the margin for satisfying the constraint increases. As a result, the constraint is suppressed from being violated.

### Second Embodiment

A second embodiment is a computer that is capable of generating a model in which a behavior that violates a constraint is suppressed when a model for base station control of a wireless access network is generated by constrained reinforcement learning.

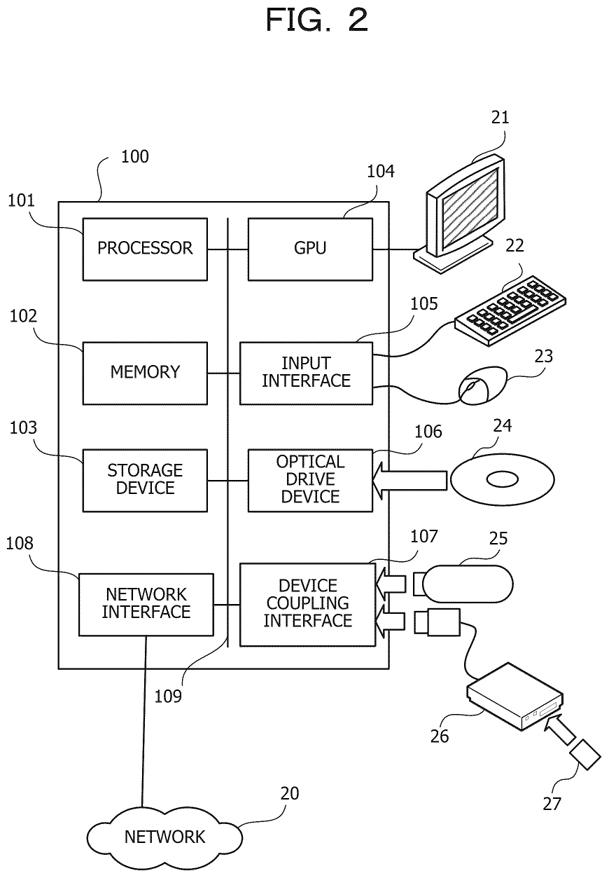

FIG. 2 is a diagram illustrating an example of hardware of the computer. The entirety of a computer 100 is controlled by a processor 101. A memory 102 and a plurality of peripheral devices are coupled to the processor 101 via a bus 109. The processor 101 may be a multiprocessor. The processor 101 is, for example, a central processing unit (CPU), a microprocessor unit (MPU), or a digital signal processor (DSP). At least a part of a function realized by the processor 101 executing a program may be realized by an electronic circuit such as an application-specific integrated circuit (ASIC) or a programmable logic device (PLD).

The memory 102 is used as a main storage device of the computer 100. The memory 102 temporarily stores at least a part of an operating system (OS) program or an application program to be executed by the processor 101. The memory 102 stores various types of data to be used for the processing by the processor 101. As the memory 102, for example, a volatile semiconductor storage device such as a random-access memory (RAM) is used.

The peripheral devices coupled to the bus 109 include a storage device 103, a graphics processing unit (GPU) 104, an input interface 105, an optical drive device 106, a device coupling interface 107, and a network interface 108.

The storage device 103 writes and reads data electrically or magnetically to and from a built-in recording medium. The storage device 103 is used as an auxiliary storage device of the computer 100. The storage device 103 stores an OS program, an application program, and various types of data. As the storage device 103, for example, a hard disk drive (HDD) or a solid-state drive (SSD) may be used.

The GPU 104 is a calculation device that performs image processing. The GPU 104 is an example of a graphic controller. A monitor 21 is coupled to the GPU 104. The GPU 104 displays an image on a screen of the monitor 21 in accordance with a command from the processor 101. As the monitor 21, a display device using organic electro luminescence (EL), a liquid crystal display device, or the like is used.

A keyboard 22 and a mouse 23 are coupled to the input interface 105. The input interface 105 transmits signals transmitted from the keyboard 22 or the mouse 23 to the processor 101. The mouse 23 is an example of a pointing device, and other pointing devices may be used. Examples of the other pointing devices include a touch panel, a tablet, a touch pad, a track ball, or the like.

The optical drive device 106 reads data recorded in an optical disc 24 or writes data to the optical disc 24 by using laser light or the like. The optical disc 24 is a portable-type recording medium in which data is recorded such that the data is readable by reflection of light. Examples of the optical disc 24 include a Digital Versatile Disc (DVD), a DVD-RAM, a compact disc read-only memory (CD-ROM), a CD-recordable (CD-R), a CD-rewritable (CD-RW), and the like.

The device coupling interface 107 is a communication interface for coupling the peripheral devices to the computer 100. For example, a memory device 25 or a memory reader and writer 26 may be coupled to the device coupling interface 107. The memory device 25 is a recording medium provided with the function of communicating with the device coupling interface 107. The memory reader and writer 26 is a device that writes data to a memory card 27 or reads data from the memory card 27. The memory card 27 is a card-type recording medium.

The network interface 108 is coupled to a network 20. The network interface 108 transmits and receives data to and from another computer or a communication device via the network 20. The network interface 108 is, for example, a wired communication interface that is coupled to a wired communication device such as a switch or a router by a cable. The network interface 108 may be a wireless communication interface that is coupled, by radio waves, to and communicates with a wireless communication device such as a base station or an access point.

With the hardware as described above, the computer 100 may realize processing functions of the second embodiment. The computer 100 is an example of the information processing apparatus 10 described in the first embodiment. The information processing apparatus 10 described in the first embodiment may also be realized by substantially the same hardware as that of the computer 100 illustrated in FIG. 2.

For example, the computer 100 realizes the processing functions of the second embodiment by executing a program recorded in a computer-readable recording medium. A program in which the content of processing to be executed by the computer 100 is described may be recorded in any of various recording media. For example, a program to be executed by the computer 100 may be stored in the storage device 103. The processor 101 loads at least a part of the program in the storage device 103 to the memory 102, and executes the program. The program to be executed by the computer 100 may be recorded in a portable-type recording medium such as the optical disc 24, the memory device 25, or the memory card 27. The program stored in the portable-type recording medium may be executed after the program is installed in the storage device 103 under the control of the processor 101, for example. The processor 101 may read the program directly from the portable-type recording medium and execute the program.

The computer 100 may reproduce an environment of a wireless access network by a software simulation. By the computer 100 performing the simulation of the environment of the wireless access network, it is possible to acquire the power consumption and the load of the base station without being coupled to an actual wireless access network environment. Accordingly, the constrained reinforcement learning may be efficiently performed.

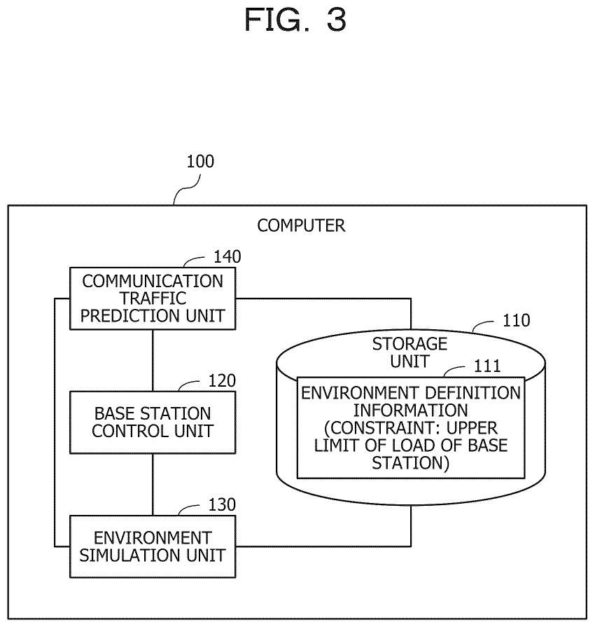

FIG. 3 is a block diagram illustrating an example of functions of the computer for realizing the constrained reinforcement learning. The computer 100 includes a storage unit 110, a base station control unit 120, an environment simulation unit 130, and a communication traffic prediction unit 140.

The storage unit 110 stores environment definition information 111. The environment definition information 111 is information related to an environment of a wireless access network. For example, information such as a performance of each base station and an upper limit of a load of a base station is included in the environment definition information 111.

Based on a predicted value of a communication traffic amount obtained from the communication traffic prediction unit 140 and a predicted reliability, the base station control unit 120 performs state control (active/sleep) of the base station by using a machine learning model, and dynamically corrects a parameter of the model. The predicted reliability is represented by, for example, a prediction variance. The prediction variance is an index indicating how much a predicted output varies from a true value. The true value is, for example, an average value (expected value) of probability distributions when a probability that each of candidate values (possible values of random variables) of a communication traffic amount is a correct value follows a predetermined probability distribution. The probability distribution is, for example, a Gaussian distribution (normal distribution). For example, the true value is the same value as the calculated predicted traffic amount.

After determining the state of each base station as an action by using a machine learning model, the base station control unit 120 instructs the environment simulation unit 130 about the state of each base station. As a result of applying the action, the base station control unit 120 acquires state information of the wireless access network from the environment simulation unit 130. Examples of the acquired state information include power consumption and a load of each base station. Based on the acquired state information, the base station control unit 120 corrects the model. For example, the model is a neural network. In this case, the base station control unit 120 corrects an inter-neuron weight parameter.

Based on the environment definition information 111, the environment simulation unit 130 simulates a change in the state of the environment defined by a problem of reinforcement learning. For example, the environment simulation unit 130 simulates the load and the power consumption of each base station based on the sleep control (which base station is set to the sleep state) of the base station in the wireless access network.

For example, the environment simulation unit 130 determines a current communication traffic amount in accordance with a schedule set in advance. The environment simulation unit 130 may determine the communication traffic amount at each time in the simulation so as to reproduce time transition of the communication traffic amount in the actual wireless access network.

The environment simulation unit 130 transmits the load and the power consumption of each base station obtained as a simulation result to the base station control unit 120. The environment simulation unit 130 transmits the current communication traffic amount to the communication traffic prediction unit 140.

Based on the past and current communication traffic amounts, the communication traffic prediction unit 140 predicts a subsequent communication traffic amount. For example, the communication traffic prediction unit 140 predicts the communication traffic amount by using a trained model for communication traffic prediction. For example, the model for communication traffic amount prediction is a neural network. At the same time, the communication traffic prediction unit 140 obtains a prediction variance indicating a reliability of the prediction result when predicting the subsequent communication traffic amount after a predetermined period of time. The communication traffic prediction unit 140 transmits the predicted communication traffic amount and the prediction variance to the base station control unit 120.

For example, the function of each element illustrated in FIG. 3 may be realized by causing the processor 101 to execute a program module corresponding to the element.

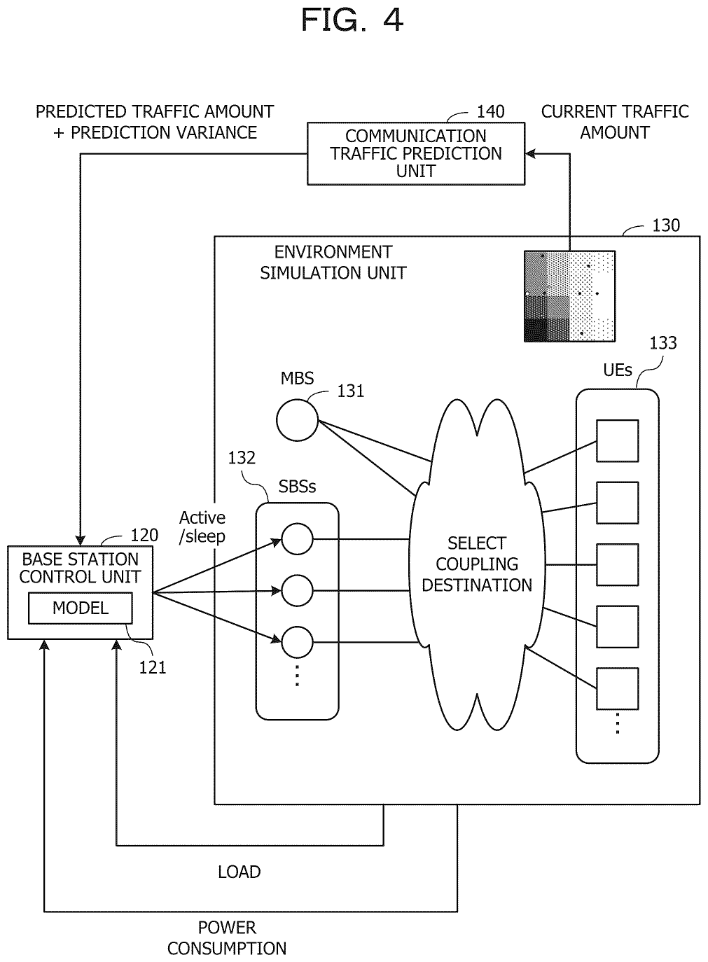

FIG. 4 is a diagram illustrating an example of a constrained reinforcement learning operation. For example, the environment simulation unit 130 simulates operations of a macro base station (MBS) 131, a plurality of small base stations (SBSs) 132, and a plurality of user equipment (UEs) 133 by using software. Hereinafter, when called a base station, it is assumed that the base station includes the macro base station 131 and the plurality of small base stations 132.

For example, the environment simulation unit 130 sets a state of each of the plurality of small base stations 132 in accordance with an instruction on the state (active or sleep) of each of the plurality of small base stations 132 from the base station control unit 120.

The environment simulation unit 130 reproduces occurrence statuses of communication requests by each of the plurality of user equipment 133 in accordance with a predetermined algorithm. The environment simulation unit 130 reproduces an operation of selecting the base station that is a coupling destination by each of the plurality of user equipment 133, and selects a coupling destination. At this time, the macro base station 131 or the small base station in the active state may be the coupling destination.

Based on a communication coupling status of each of the plurality of user equipment 133, the environment simulation unit 130 calculates a load of each of the macro base station 131 and the plurality of small base stations 132. The environment simulation unit 130 calculates power consumption of each of the macro base station 131 and the plurality of small base stations 132, based on the communication coupling status of each of the plurality of user equipment 133, and the state of each base station.

The environment simulation unit 130 transmits the load and the power consumption of each base station to the base station control unit 120. The environment simulation unit 130 calculates a communication traffic amount between each of the base stations and each of the plurality of user equipment 133. As a current traffic amount, the environment simulation unit 130 transmits the calculated communication traffic amount to the communication traffic prediction unit 140.

The communication traffic prediction unit 140 predicts a subsequent communication traffic amount between each of the base stations and each of the plurality of user equipment 133. The communication traffic prediction unit 140 calculates a prediction variance of the traffic amount. The communication traffic prediction unit 140 transmits the predicted traffic amount and the prediction variance to the base station control unit 120.

The base station control unit 120 acquires a current load and power consumption of each base station from the environment simulation unit 130. The base station control unit 120 acquires the communication traffic amount and the prediction variance from the communication traffic prediction unit 140. Based on the acquired information, the base station control unit 120 determines the state of each of the plurality of small base stations 132 by using a model 121.

The base station control unit 120 corrects a parameter of the model 121 based on the load and the power consumption of each base station. At this time, the base station control unit 120 makes a reward larger as the power consumption of each base station is smaller. In a case where the load of each base station exceeds a threshold indicated by a constraint on the load, the base station control unit 120 increases a penalty. The base station control unit 120 corrects the parameter of the model 121 such that the reward becomes larger and the penalty becomes smaller. Accordingly, the constrained reinforcement learning is advanced.

In the example illustrated in FIG. 4, in addition to the predicted traffic amount, the communication traffic prediction unit 140 transmits the prediction variance to the base station control unit 120, and the base station control unit 120 obtains the states of the plurality of small base stations 132 by using the prediction variance. A reason why the prediction variance is used to obtain the states of the plurality of small base stations 132 is to suppress the constraint from being violated.

For example, when the constrained reinforcement learning is performed without using the prediction variance, the constraint on the load is often violated. Although the constraint becomes less likely to be violated by increasing the penalty when the constraint is violated, in a case where the penalty is too large, reinforcement learning does not proceed, and it is difficult to generate the model 121 with high accuracy.

By using information on a reliability of prediction such as the prediction variance in the constrained reinforcement learning, in a case where the reliability is high, the base station control unit 120 may determine an action that significantly reduces power consumption within a range in which the constraint is observed. In a case where the reliability is low, the base station control unit 120 may determine an action in which a margin to the threshold of the load is large so as not to violate the constraint. As a result, it is possible to suppress the constraint from being violated.

The prediction variance will be described next.

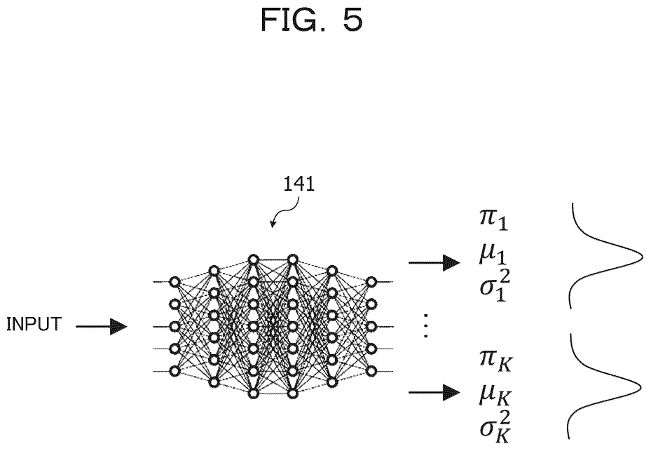

FIG. 5 is a diagram illustrating an example of the prediction variance. For example, the communication traffic prediction unit 140 assumes that a data sequence for training is based on a certain distribution, and predicts an average and a variance of the distribution as an output of a model 141. As the model 141, for example, a neural network in which a mixture density network (MDN) is provided on an output side of a long short-term memory (LSTM) network is used. In this case, the variance of the predicted traffic amount is calculated by the MDN.

For example, the communication traffic prediction unit 140 assumes a Gaussian mixture distribution by the MDN, and predicts a Gaussian mixture coefficient n, an average u, and a variance o of each distribution.

By using the MDN, training is performed by using, as a loss function, a minimum value of a negative log-likelihood represented by Formula (1) below.

$$- ln ( {\sum }_{k = 1}^{K} {π}_{k} ( x ) N ( y \vert {μ}_{k} ( x ) {Σ}_{k} ( x ) ) ) \qquad ( 1 )$$

In Formula (1), N ( ) is a probability density function of Gaussian distribution. Σ is a variance-covariance matrix. y is a teaching signal. x is an input to the model 141. In the example illustrated in FIG. 5, K (K is a natural number) sets of the Gaussian mixture coefficient π, the average μ, and the variance δ are output. For example, an average of K variances δ obtained by the MDN may be set as the prediction variance of the predicted traffic amount. Details of the MDN are described in Christopher M. Bishop, “Mixture Density Networks”, Neural Computing Research Group Report (NCRG/94/004), Aston University, February 1994.

The model 141 for communication traffic prediction has been trained in advance. For example, the communication traffic prediction unit 140 divides a region of the wireless access network into a plurality of partial regions. For each partial region, the communication traffic prediction unit 140 calculates a predicted traffic amount and a prediction variance.

The predicted traffic amount and the prediction variance for each partial region are used for training and prediction of the model 121 in the base station control unit 120.

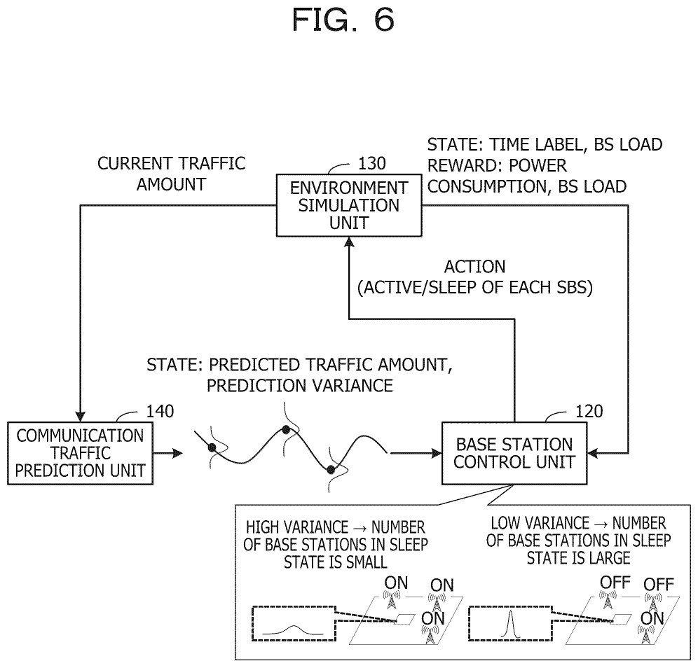

FIG. 6 is a diagram illustrating an example of the action by the constrained reinforcement learning in the second embodiment. The prediction variance predicted by the communication traffic prediction unit 140 is an input to a constrained reinforcement learning method in the base station control unit 120. For example, the base station control unit 120 trains the model 121 by using the state of the wireless access network (load of the base station), the predicted traffic amount, and the value reflecting the reliability (prediction variance) to the model 121 as inputs.

For example, the base station control unit 120 determines an action regarding the state of the small base station (whether to be made active or sleep) based on the output from the model 121. The base station control unit 120 instructs the environment simulation unit 130 to perform the determined action. Based on the determined action, the environment simulation unit 130 performs a simulation of the environment of the wireless access network, and transmits a state (a time label and a load of each base station) and a reward (power consumption and a load of each base station) to the base station control unit 120. The base station control unit 120 gives a penalty (negative reward) in a case where a load of any base station exceeds a threshold. The base station control unit 120 makes the reward larger as the power consumption is smaller. The base station control unit 120 may the reward larger as the load of the base station is smaller. The base station control unit 120 updates the parameter of the model 121 such that the reward is larger (the penalty is lower).

By repeatedly executing the training based on the predicted traffic amount and the prediction variance, the base station control unit 120 improves the accuracy of the model 121. Accordingly, the base station control unit 120 trains the model about a behavior such as “reliability (variance value) is high/low→risk is not taken/taken” in an action of the next time (for example, after ten minutes). For example, in the case of taking a risk, training is performed such that a difference between a predicted load and a threshold of the load is smaller than that in the case where a risk is not taken.

As a result, after sufficient training is performed, in a case where the variance is high, the base station control unit 120 keeps the number of small base stations to be caused to sleep to a small number. On the other hand, in a case where the variance is low, the base station control unit 120 causes many small base stations to sleep. Accordingly, an occurrence of a situation in which the load of the base station exceeds the threshold (constraint is violated) is suppressed.

As described above, by using the prediction variance indicating the reliability of the predicted traffic amount for the constrained reinforcement learning, for example, even when the predicted traffic amounts are the same, when the prediction variances are different, the determined action is also different. By advancing the training so as to increase the reward, the model 121 in which the occurrence of the situation where the constraint is violated is suppressed is generated.

A processing procedure of the constrained reinforcement learning in which the constraint is suppressed from being violated will be described next.

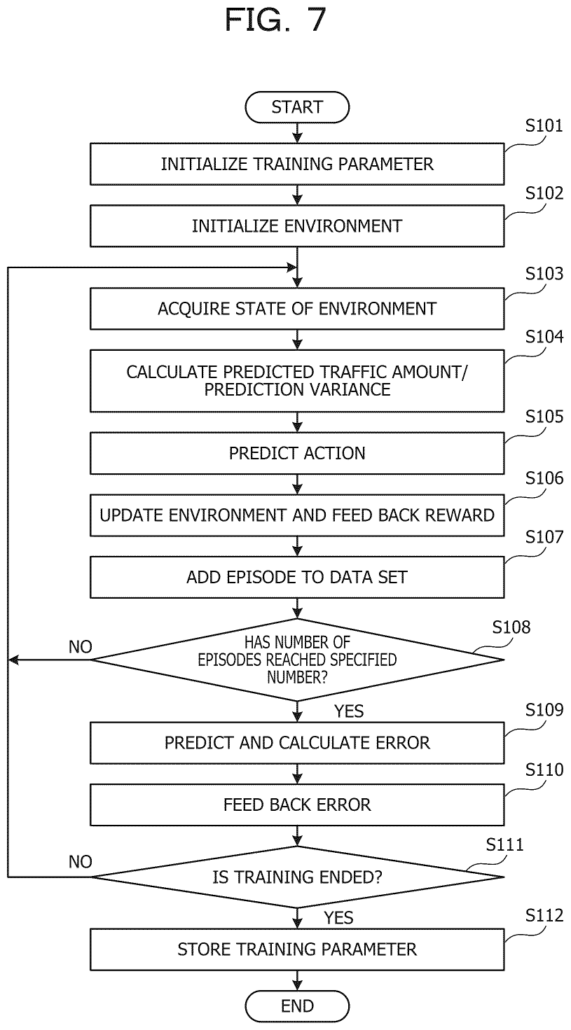

FIG. 7 is a flowchart illustrating an example of the processing procedure of the constrained reinforcement learning. Hereinafter, the processing illustrated in FIG. 7 will be described in order of step numbers.
[Step S101] The base station control unit 120 initializes a training parameter.
[Step S102] The environment simulation unit 130 initializes an environment of a wireless access network.
[Step S103] The base station control unit 120 acquires a state of the environment. For example, the base station control unit 120 acquires a time label, a load of a base station, and a current traffic amount. For example, the current traffic amount is a traffic amount of each of a plurality of partial regions obtained by dividing a region of the wireless access network.
[Step S104] Based on the current traffic amount, the communication traffic prediction unit 140 calculates, for each partial region, a communication traffic amount and a prediction variance of a next time (for example, after ten minutes) in the environment simulation.
[Step S105] The base station control unit 120 predicts an action of the next time in the environment simulation. For example, the base station control unit 120 performs calculation in accordance with the model 121 by using the current load of each base station, the predicted traffic amount for each partial region, and the prediction variance for each partial region as input data to the model 121. The calculation result indicates a predicted action.

As for the load of each base station, the base station control unit 120 may include not only the current load but also a load within a predetermined period in the past in the input data. The base station control unit 120 may include the current communication traffic amount (current demand amount) in the input data.
[Step S106] Based on the predicted action, the environment simulation unit 130 updates the environment. For example, the environment simulation unit 130 causes a small base station designated as being sleep to transition to a sleep state in which power consumption is low. The environment simulation unit 130 causes a small base station that is designated as being active to transition to a state in which communication is performed in accordance with a request from the user equipment. The environment simulation unit 130 calculates a reward from the update result of the state, and feeds back the reward to the base station control unit 120.
[Step S107] The base station control unit 120 adds an episode to a data set. The episode includes information such as the predicted traffic amount and the prediction variance for each base station at a certain time in the environment simulation, the predicted state for each base station, and the load and the power consumption for each base station in the environment in the state.
[Step S108] The base station control unit 120 determines whether the number of episodes has reached a specified number. When the number of episodes reaches the specified number, the base station control unit 120 causes the processing to proceed to step S109. When the number of episodes has not been reached the specified number, the base station control unit 120 causes the processing to proceed to step S103.
[Step S109] The base station control unit 120 inputs each of the episodes included in the data set to the model 121, and performs calculation in accordance with the model 121 to predict an action. For the active base station, the base station control unit 120 calculates an error between a value indicating a magnitude of a reward assumed at the time of the prediction and a value indicating a magnitude of the reward obtained from the fed back load and power consumption. The value indicating the magnitude of the reward is, for example, a value called a Q value.
[Step S110] The base station control unit 120 feeds back the error to the model 121. For example, the base station control unit 120 corrects the parameter of the model 121 in a direction in which the error decreases.
[Step S111] The base station control unit 120 determines whether training is ended. For example, in a case where the error is equal to or less than a certain value, the base station control unit 120 determines that the training is ended. When the training is ended, the base station control unit 120 causes the processing to proceed to step S112. When the training is continued, the base station control unit 120 causes the processing to proceed to step S103.
[Step S112] The base station control unit 120 stores the parameter for the trained model 121.

By controlling the state of the base station using the model 121 trained in this manner, it is possible to suppress a constraint from being violated. For example, a device that controls a base station in an actual wireless access network is used instead of the environment simulation unit 130. Accordingly, it is possible to appropriately perform the power-saving control of the base station in the actual wireless access network within a range in which the load does not exceed the threshold.

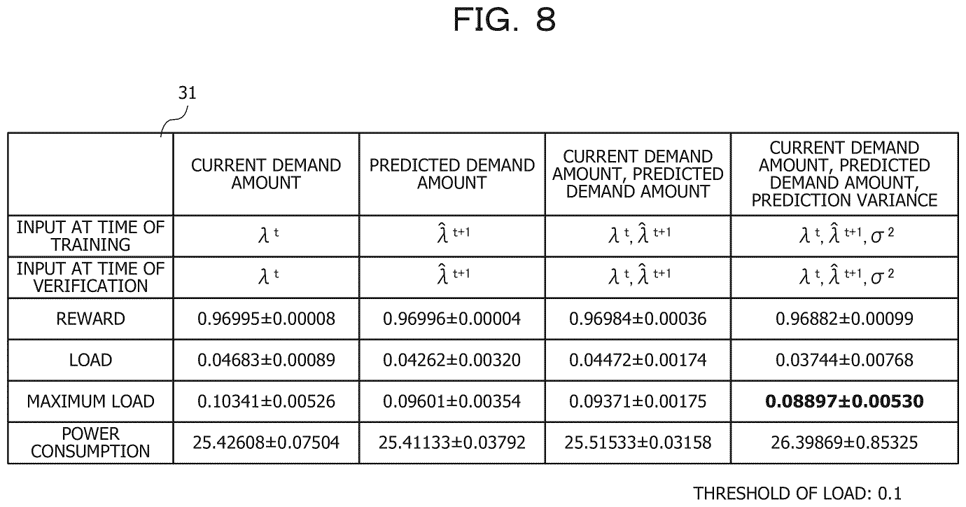

FIG. 8 is a diagram illustrating an example of a prediction result by a model obtained by the constrained reinforcement learning using the prediction variance. A prediction result comparison table 31 indicates a difference between prediction results according to a difference between pieces of information input to the model 121. Types of information input to the model 121 are the following four patterns.
1. Current demand amount λ^{t}
2. Predicted demand amount λ^{t+1} (π is with \hat{ })
3. Current demand amount λ^{t} and predicted demand amount λ^{t+1} (λ is with \hat{ })
4. Current demand amount λ^{t}, predicted demand amount At+¹ (λ is with \hat{ }), and prediction variance σ²

In the wireless access network, the current demand amount is a current traffic amount. The predicted demand amount is a predicted traffic amount. The input to the model 121 at the time of training is the same as an input at the time of verification. The threshold of the load set as the constraint is “0.1”.

The reward is a value calculated based on the load and the power consumption. A larger value of the reward indicates better performance of the model 121. A lower value of the load indicates better performance of the model 121. It is desirable to avoid as much as possible that a maximum load exceeds the threshold. A lower value of the power consumption indicates better performance of the model 121.

As indicated in the prediction result comparison table 31, the maximum load decreases by including the prediction variance in the input. Furthermore, in a case where the prediction variance is included in the input, the maximum load does not exceed the threshold of the load. For example, a constraint is observed.

For example, in a case where only the current demand amount is used for the training of the model 121, the maximum load is “0.10341±0.00526”. In this case, there is a high possibility that the load exceeds the threshold “0.1”. When only the predicted demand amount is used for the training of the model 121, the maximum load is “0.09601±0.00354”. In this case, even when the load becomes the upper limit “0.09601±0.00354” of the error of the maximum load, the load is equal to or less than the threshold of the load, but is a value considerably close to the threshold. For this reason, when there is an unexpected change in the state of the environment, there is a risk that the load exceeds a threshold. The same is true when the current demand amount and the predicted demand amount are used for the training of the model 121.

By contrast, in a case where the current demand amount, the predicted demand amount, and the prediction variance are used for the training of the model 121, the maximum load is “0.08897±0.00530”. In this case, even when the load becomes the upper limit “0.08897±0.00530” of the error of the maximum load, there is still a margin up to the threshold (0.1) of the load. For this reason, even when the environment changes unexpectedly, the load is suppressed from exceeding a threshold.

### Third Embodiment

According to a third embodiment, in the base station control unit 120, at the time of predicting an appropriate action using the model 121, a predicted traffic amount to which a margin based on a reliability is added is input to the model 121. Accordingly, for each base station, control inclined toward a safety side is performed. For example, since the predicted traffic amount is overestimated at a time when there is large variation in the prediction, an action is determined so as not to cause the small base station to sleep.

At the time of training of the model 121, it is not desired to add the margin based on the reliability to the predicted traffic amount. For example, in the third embodiment, the communication traffic prediction unit 140 does not calculate a prediction variance at the time of training. At the time of training, the base station control unit 120 does not include the prediction variance in the input to the model 121. Other processing at the time of training is similar to the processing according to the second embodiment illustrated in FIG. 7.

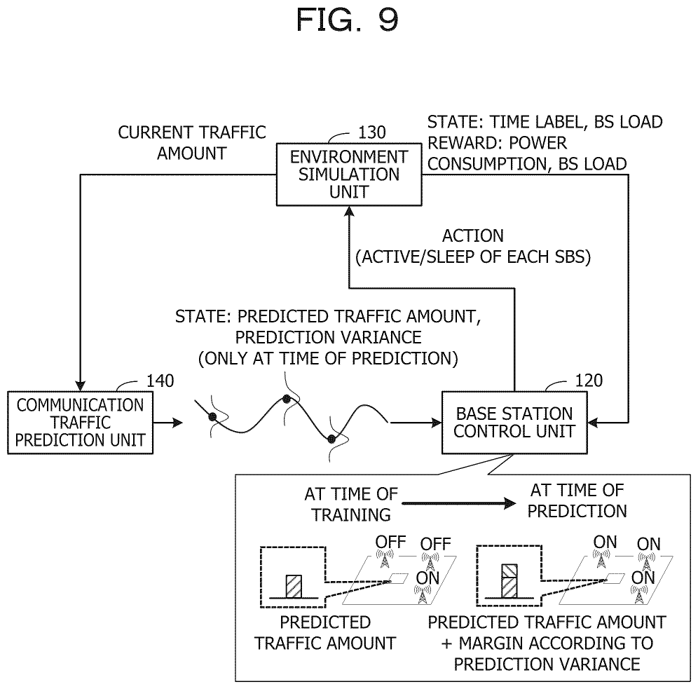

FIG. 9 is a diagram illustrating an example of an action by the constrained reinforcement learning in the third embodiment. According to the third embodiment, processing in the base station control unit 120 is different from that according to the second embodiment. At the time of training, the base station control unit 120 does not use the prediction variance. At the time of prediction, the base station control unit 120 adds a margin according to the prediction variance to the predicted traffic amount.

For example, at the time of training, based on the predicted traffic amount in a certain partial region, it is assumed that one small base station is determined to be active and two small base stations are determined to be sleep, as respective states of the three surrounding small base stations. At the time of prediction, when the same predicted traffic amount as that at the time of training is input to the model 121 for the partial region, the number of active small base stations increases. In the example of FIG. 9, it is determined that all three surrounding small base stations in this partial region are set to be active.

An amount of the margin added to the predicted traffic amount is a larger value as the prediction variance is larger. For example, “predicted traffic amount+prediction variance” is the predicted traffic amount to be input to the model 121 at the time of prediction. The user may arbitrarily set a magnitude of the margin according to the prediction variance. In this case, the magnitude of the margin is set to “a×prediction variance” (the coefficient a is a positive real number). The user may arbitrarily set the magnitude of the margin by designating the value of the coefficient a.

The processing procedure at the time of prediction when adding the margin according to the magnitude of the prediction variance to the predicted traffic amount will be described next.

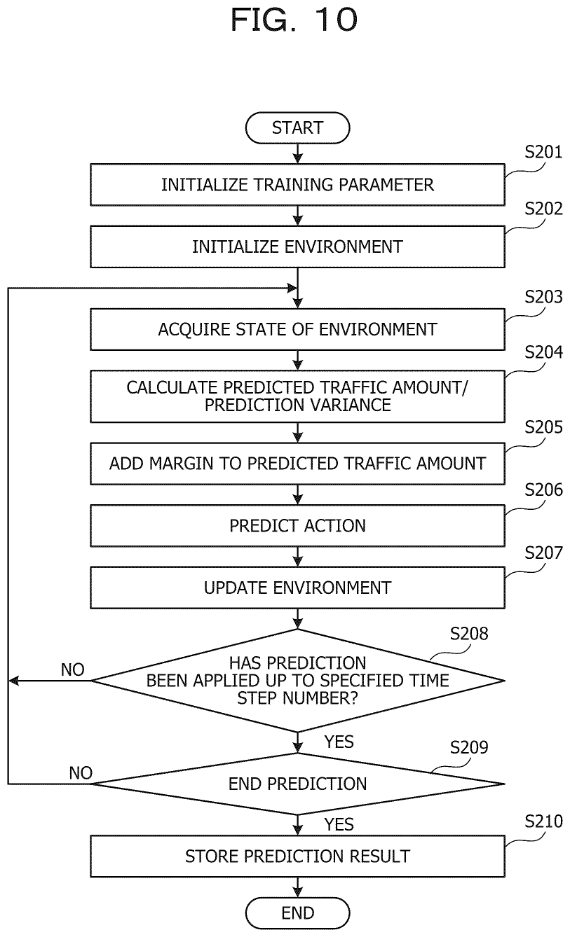

FIG. 10 is a flowchart illustrating an example of a prediction processing procedure using a trained model by the constrained reinforcement learning. Hereinafter, the processing illustrated in FIG. 10 will be described in accordance with step numbers.
[Step S201] The base station control unit 120 initializes a training parameter.
[Step S202] The environment simulation unit 130 initializes an environment of a wireless access network.
[Step S203] The base station control unit 120 acquires a state of the environment. For example, the base station control unit 120 acquires a time label, a load of a base station, and a current traffic amount. For example, the current traffic amount is a traffic amount of each of a plurality of partial regions obtained by dividing a region of the wireless access network.
[Step S204] Based on the current traffic amount, the communication traffic prediction unit 140 calculates, for each partial region, a communication traffic amount and a prediction variance of a next time (for example, after ten minutes) in the environment simulation.
[Step S205] The base station control unit 120 adds a margin to the predicted traffic amount.
[Step S206] By using the predicted traffic amount to which the margin is added, the base station control unit 120 predicts an action of the next time in the environment simulation. For example, the base station control unit 120 adds, to the predicted traffic amount for each partial region, a margin according to the prediction variance of the partial region. The base station control unit 120 includes a value after the addition of the margin in the input data to the model 121 as the predicted traffic amount, and performs calculation in accordance with the model 121. The calculation result indicates a predicted action.

[Step S207] Based on the predicted action, the environment simulation unit 130 updates the environment. For example, the environment simulation unit 130 causes a small base station designated as being sleep to transition to a sleep state in which power consumption is low. The environment simulation unit 130 causes a small base station that is designated as being active to transition to a state in which communication is performed in accordance with a request from the user equipment.

[Step S208] The base station control unit 120 determines whether the prediction has been applied up to a specified time step in the environment simulation. When the application of the prediction up to the specified time step is ended, the base station control unit 120 causes the processing to proceed to step S209. When the application of the prediction up to the specified time step is not ended, the base station control unit 120 causes the processing to proceed to step S203.

[Step S209] The base station control unit 120 determines whether to end the prediction processing. For example, in a case where an instruction to end the prediction is input from the user, the base station control unit 120 determines that the prediction is ended. In a case where the prediction is ended, the base station control unit 120 causes the processing to proceed to step S210. In a case where the prediction is continued, the base station control unit 120 causes the processing to proceed to step S203.

[Step S210] The base station control unit 120 stores the prediction result in the memory 102 or the storage device 103. Examples of the prediction result include information such as the state of the environment (including the load of the base station and the communication traffic amount), the predicted traffic amount, the prediction variance, and the action of the next time.

By coupling to the device that actually controls the base station instead of the environment simulation unit 130 and controlling the base station based on the action predicted in the processing illustrated in FIG. 10, it is possible to perform power-saving base station control in which the violation of the constraint in the wireless access network is suppressed.

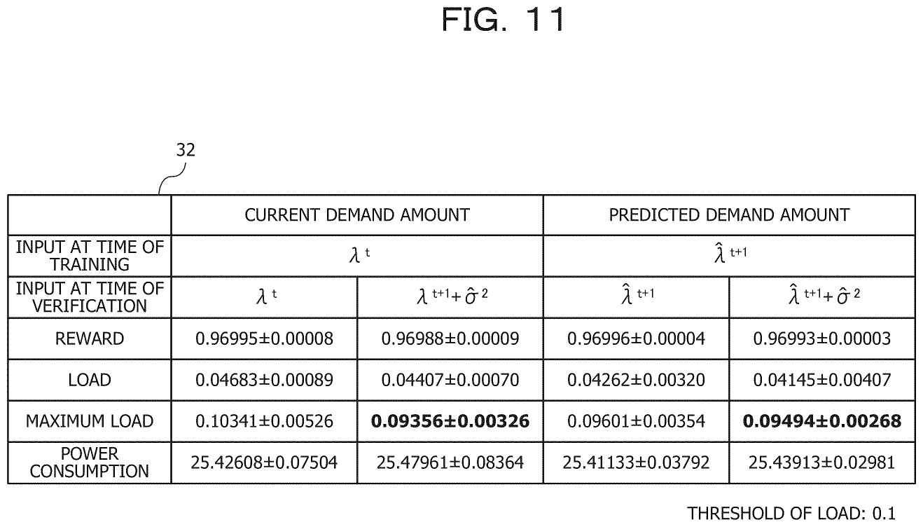

FIG. 11 is a diagram illustrating an example of a verification result in a case where the predicted traffic amount to which the margin according to the prediction variance is added is input. A prediction result comparison table 32 indicates prediction results in a case where the margin according to the prediction variance is included and a case where the margin is not included at the time of prediction. The information used for input to the model 121 at the time of prediction has the following two patterns.
1. Current demand amount λ^{t}
2. Predicted demand amount λ^{t+1} (λ is with \hat{ })

The prediction result comparison table 32 indicates prediction

results in a case where a value of a prediction variance σ² (σ is with \hat{ }) is added to a predicted demand amount (predicted traffic amount) and a case where the value is not added at the time of verifying prediction accuracy for each pattern of input. For example, in a case where the current demand amount is used as the input, the input to the model 121 at the time of training remains a value of the current demand amount, and the input at the time of verification is the current demand amount+the prediction variance. When the predicted demand amount is used as the input, the input to the model 121 at the time of training remains a value of the predicted demand amount, and the input at the time of verification is the predicted demand amount+the prediction variance. A threshold of the load defined as the constraint is “0.1”.

As indicated in the prediction result comparison table 32, in a case where the margin according to the prediction variance is added to the predicted demand amount, the maximum value of the load decreases. As a result, a situation in which the maximum value of the load exceeds the threshold (constraint is violated) is suppressed.

For example, in a case where the current demand amount is used, the maximum load is “0.10341±0.00526” unless the margin according to the prediction variance is added. In this case, there is a high possibility that the load exceeds the threshold of the load. By contrast, the maximum load is “0.09356±0.00326” by adding the margin according to the prediction variance to the predicted demand amount. In this case, even when the load becomes the upper limit “0.09356±0.00326” of the error, the load is still equal to or less than the threshold of the load.

A more accurate prediction may be made when the predicted demand amount is used, and the maximum value of the load decreases than that in the case where the current demand amount is used. However, when the addition of the margin according to the prediction variance is not performed, the maximum load is “0.09601±0.00354”. In this case, the upper limit “0.09601±0.00354” of the error is equal to or less than the threshold of the load, but is a value considerably close to the threshold. For this reason, there is a risk that the load exceeds the maximum value even with an unexpected slight change in the environment. By contrast, the maximum load is “0.09494±0.00268” by adding the margin according to the prediction variance to the predicted demand amount. In this case, even when the load becomes the upper limit “0.09494±0.00268” of the error, there is still a margin up to the threshold of the load. For this reason, even when the environment changes unexpectedly, the load is suppressed from exceeding a threshold.

### Other Embodiments

A model trained by the reinforcement learning described in the second and third embodiments may be effectively used for management of a wireless base station in an organization, such as a mobile phone company, that operates a wireless access network.

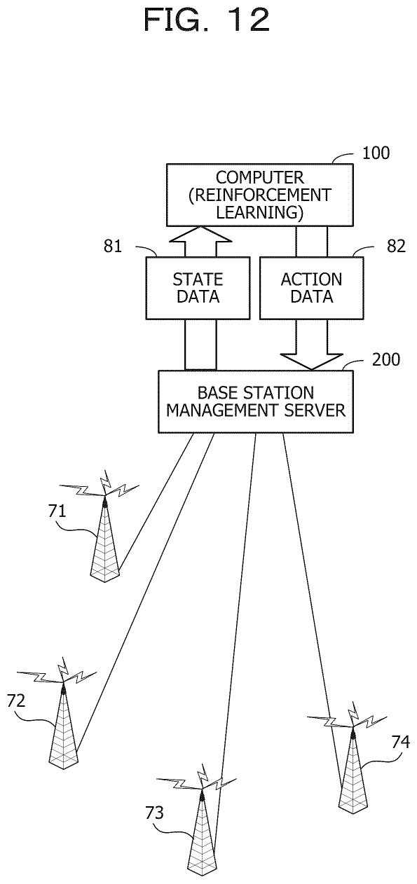

FIG. 12 illustrates an example of a base station management system in a wireless access network. For example, a base station management server 200 manages operation states (active or sleep) of wireless base stations 71 to 74. The base station management server 200 may acquire information such as a traffic amount at each time in each of the base stations 71 to 74, a usage rate of the base station, and power consumption. The base station management server 200 transmits the acquired information as state data 81 to the computer 100.

The computer 100 causes the environment simulation unit 130 to imitate the operation of the wireless access network to execute reinforcement learning, and generates a model in which a policy that maximizes a reward is set. The computer 100 inputs the state indicated by the state data 81 acquired from the base station management server 200 to the model, and determines an action (whether to make each base station active or sleep). The computer 100 transmits action data 82 indicating the determined action to the base station management server 200. Based on the action data 82, the base station management server 200 controls the operation states of the base stations 71 to 74.

After acquiring the state data 81 indicating the states of the base stations 71 to 74 after the transmission of the action data 82 from the base station management server 200, the computer 100 calculates a reward for the instructed action. The computer 100 updates the policy of the model so that the reward becomes higher. Accordingly, an accurate model is generated, and power saving in the wireless access network is promoted.

Although the reinforcement learning is performed in the computer 100 different from the base station management server 200 in the example of FIG. 12, the reinforcement learning may be performed in the base station management server 200.

The embodiments are exemplified above, the configuration of each unit described in the embodiments may be replaced with another unit having the same function. Other arbitrary components or processes may be added. Arbitrary two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a reinforcement learning program for causing a computer to execute a process comprising:
calculating a second demand amount after a certain period of time and a reliability of the second demand amount based on a current first demand amount for a service provided in a predetermined environment;
determining an action to be performed for the environment in accordance with a machine learning model based on input data that includes the second demand amount, the reliability, and a current first state of the environment;
executing the determined action for the environment; and
updating, based on a second state of the environment after the action is performed and a reward, a parameter of the model by constrained reinforcement learning in which the reward is increased in a range that satisfies a constraint on the state of the environment.

2. The non-transitory computer-readable recording medium according to claim 1, wherein
in the calculating the second demand amount and the reliability, a communication environment of a wireless access network is set as the environment, a current first communication traffic amount of the wireless access network is set as the first demand amount, and based on the first communication traffic amount, a second communication traffic amount after a certain period of time in the wireless access network is calculated as the second demand amount,
in the determining the action, whether to cause the base station to be active or sleep is determined as the action by using a load of the base station in the wireless access network as the first state, and
in the updating the parameter of the model, a penalty is generated when a second load of the base station after controlling the base station in accordance with the determined action exceeds a threshold related to the load of the base station, a larger value is set as the reward as power consumption of the base station after controlling the base station is smaller, and the parameter of the model is updated so as to increase the reward without generating the penalty.

3. The non-transitory computer-readable recording medium according to claim 1, wherein
in the calculating the second demand amount and the reliability, a variance of the second demand amount is calculated as the reliability.

4. A non-transitory computer-readable recording medium storing a reinforcement learning program for causing a computer to execute a process comprising:
calculating a second demand amount after a certain period of time and a reliability of the second demand amount based on a current first demand amount for a service provided in a predetermined environment;
determining, based on input data that includes a third demand amount obtained by adding a value according to the reliability to the second demand amount and a current first state of the environment, an action to be performed for the environment in accordance with a model generated by constrained reinforcement learning that increases a reward in a range that satisfies a constraint on a state of the environment; and
executing the determined action for the environment.

5. A reinforcement learning method performed by a computer, the method comprising:
calculating a second demand amount after a certain period of time and a reliability of the second demand amount based on a current first demand amount for a service provided in a predetermined environment;
determining an action to be performed for the environment in accordance with a machine learning model based on input data that includes the second demand amount, the reliability, and a current first state of the environment;
executing the determined action for the environment; and
updating, based on a second state of the environment after the action is performed and a reward, a parameter of the model by constrained reinforcement learning in which the reward is increased in a range that satisfies a constraint on the state of the environment.

6. The reinforcement learning method according to claim 5, wherein
in the calculating the second demand amount and the reliability, a communication environment of a wireless access network is set as the environment, a current first communication traffic amount of the wireless access network is set as the first demand amount, and based on the first communication traffic amount, a second communication traffic amount after a certain period of time in the wireless access network is calculated as the second demand amount,
in the determining the action, whether to cause the base station to be active or sleep is determined as the action by using a load of the base station in the wireless access network as the first state, and
in the updating the parameter of the model, a penalty is generated when a second load of the base station after controlling the base station in accordance with the determined action exceeds a threshold related to the load of the base station, a larger value is set as the reward as power consumption of the base station after controlling the base station is smaller, and the parameter of the model is updated so as to increase the reward without generating the penalty.

7. The reinforcement learning method according to claim 5, wherein
in the calculating the second demand amount and the reliability, a variance of the second demand amount is calculated as the reliability.

8. A reinforcement learning apparatus comprising:
a memory, and
a processor, coupled to the memory and configured to:
calculate a second demand amount after a certain period of time and a reliability of the second demand amount based on a current first demand amount for a service provided in a predetermined environment;
determine an action to be performed for the environment in accordance with a machine learning model based on input data that includes the second demand amount, the reliability, and a current first state of the environment;
execute the determined action for the environment; and
update, based on a second state of the environment after the action is performed and a reward, a parameter of the model by constrained reinforcement learning in which the reward is increased in a range that satisfies a constraint on the state of the environment.

9. The reinforcement learning apparatus according to claim 8, wherein
in the calculating the second demand amount and the reliability, a communication environment of a wireless access network is set as the environment, a current first communication traffic amount of the wireless access network is set as the first demand amount, and based on the first communication traffic amount, a second communication traffic amount after a certain period of time in the wireless access network is calculated as the second demand amount,
in the determining the action, whether to cause the base station to be active or sleep is determined as the action by using a load of the base station in the wireless access network as the first state, and
in the updating the parameter of the model, a penalty is generated when a second load of the base station after controlling the base station in accordance with the determined action exceeds a threshold related to the load of the base station, a larger value is set as the reward as power consumption of the base station after controlling the base station is smaller, and the parameter of the model is updated so as to increase the reward without generating the penalty.

10. The reinforcement learning apparatus according to claim 8, wherein
in the calculating the second demand amount and the reliability, a variance of the second demand amount is calculated as the reliability.
